(19) United States
(12) Patent Application Publication
(10) Pub. No.: US 2013/0178994 A1
(43) Pub. Date: Jul. 11, 2013

(54) POWER METERING AND LOAD CONTROL DEVICE

(71) Applicants: Nagaraju Valluri, Irving, TX (US); Timothy Worthington, Crestwood, KY (US); John K. Besore, Prospect, KY (US); Joshua Blake Huff, Louisville, KY (US)

(72) Inventors: Nagaraju Valluri, Irving, TX (US); Timothy Worthington, Crestwood, KY (US); John K. Besore, Prospect, KY (US); Joshua Blake Huff, Louisville, KY (US)

(21) Appl. No.: 13/347,966

(22) Filed: Jan. 11, 2012

(51) Int. Cl. G05F 5/00

(52) U.S. Cl. 700/292

(57) ABSTRACT

A power measurement device for monitoring power delivered from a source of electrical power to a load, includes a controller configured to receive a line voltage supply input and a current input, the current input being indicative of a current drawn by the load, a load control device coupled between the controller and the load and configured to interrupt power supplied to the load through the measurement device, and a configuration module coupled to the controller and configured to enable rule-based configuration of the measurement device. The controller includes a memory in communication with a processor, the memory including program instructions for execution by the processor to calculate a value of power consumed by the load, compare the value of the power consumed to at least one predetermined control parameter, and enable the load control device to interrupt power to the load based on the comparison.

### BACKGROUND

The present disclosure generally relates to energy management of household consumer appliances, and more particularly to monitoring and controlling power consumption of loads in residential applications.

In a typical, multi-phase, residential power system, the measurement of total power consumption requires a physical electrical connection between each input voltage leg and the measurement device. For a two-phase residential system, two separate connections are required, one for each voltage leg, L1, L2.

To reduce the need for multiple electrical connections, measurement devices have been developed that use a single voltage source, along with additional circuitry, to measure power consumption in a single or polyphase environment. One example of a device that utilizes the voltage at the power outlet to measure voltage without making connections to the panel is disclosed in U.S. patent application Ser. No. 13/081,844. Since the measurement device needs to be powered, typically by plugging it into a power outlet, to perform the measurement functions, the measurement device can measure the voltage at the outlet and calculate power consumption based on the measured voltage and the two separate current values on each leg, L1, L2.

Excessive power draw from electrical equipment can be associated with certain safety hazards such as circuit overload, overheating and malfunction. Also, monitoring of the electrical power supply can be helpful in determining undervoltage and overvoltage conditions, or transients on the power lines, which can be detrimental to the proper operation of the equipment, as well as pose safety concerns. Additionally, monitoring of power consumption in conjunction with the costs associated with such power consumption can be advantageous in optimizing home energy usage and operating electrical equipment in an economically efficient fashion.

Accordingly, it would be desirable to provide a system that addresses at least some of the problems and needs identified above.

### BRIEF DESCRIPTION OF THE DISCLOSED EMBODIMENTS

As described herein, the exemplary embodiments overcome one or more of the above or other disadvantages known in the art.

One aspect of the disclosed embodiments relates to a power measurement device for monitoring power delivered from a source of electrical power to a load. In one embodiment, the power measurement device includes a controller configured to receive a line voltage supply input and a current input, the current input being indicative of a current drawn by the load, a load control device coupled between the controller and the load and configured to interrupt power supplied to the load through the measurement device, and a configuration module coupled to the controller and configured to enable rule-based configuration of the measurement device. The controller includes a memory in communication with a processor, the memory including program instructions for execution by the processor to calculate a value of power consumed by the load, compare the value of the power consumed to at least one predetermined control parameter, and enable the load control device to interrupt power to the load based on the comparison.

Another aspect of the disclosed embodiments relates to a system for measuring power consumption of at least one device coupled to an AC power source. In one embodiment, the system comprises a controller having at least one voltage input for receiving a voltage from the AC power source to which the device is connected and at least one current measurement input for receiving values of current being drawn by the device. The controller includes a memory in communication with a processor, the memory including program instructions for execution by the processor to calculate a power consumption of the device based on the at least one voltage input and the at least one current measurement input. A load control device is coupled to the controller and configured to interrupt power to the device. The memory also includes program instructions for execution by the processor to compare the power consumption of the device to at least one pre-determined threshold value, and enable the load control device to interrupt power to the load based on the at least one pre-determined threshold value.

These and other aspects and advantages of the exemplary embodiments will become apparent from the following detailed description considered in conjunction with the accompanying drawings. It is to be understood, however, that the drawings are designed solely for purposes of illustration and not as a definition of the limits of the invention, for which reference should be made to the appended claims. Moreover, the drawings are not necessarily drawn to scale and unless otherwise indicated, they are merely intended to conceptually illustrate the structures and procedures described herein.

In addition, any suitable size, shape or type of elements or materials could be used.

### BRIEF DESCRIPTION OF THE DRAWINGS

In the drawings:

FIG. 1 illustrates a block diagram of an exemplary system for measuring power consumption and controlling loads in accordance with the aspects of the disclosed embodiments.

FIG. 2 illustrates a perspective view of an exemplary power measurement device incorporating aspects of the disclosed embodiments.

FIG. 3 illustrates a block diagram of an exemplary system for measuring power consumption and controlling loads in accordance with aspects of the disclosed embodiments.

FIG. 4 illustrates an exemplary process flow diagram for measuring power consumption and controlling loads in a system incorporating aspects of the disclosed embodiments.

FIG. 5 illustrates exemplary configuration menus for a power measurement device incorporating aspects of the disclosed embodiments.

### DETAILED DESCRIPTION OF THE EXEMPLARY EMBODIMENTS OF THE DISCLOSURE

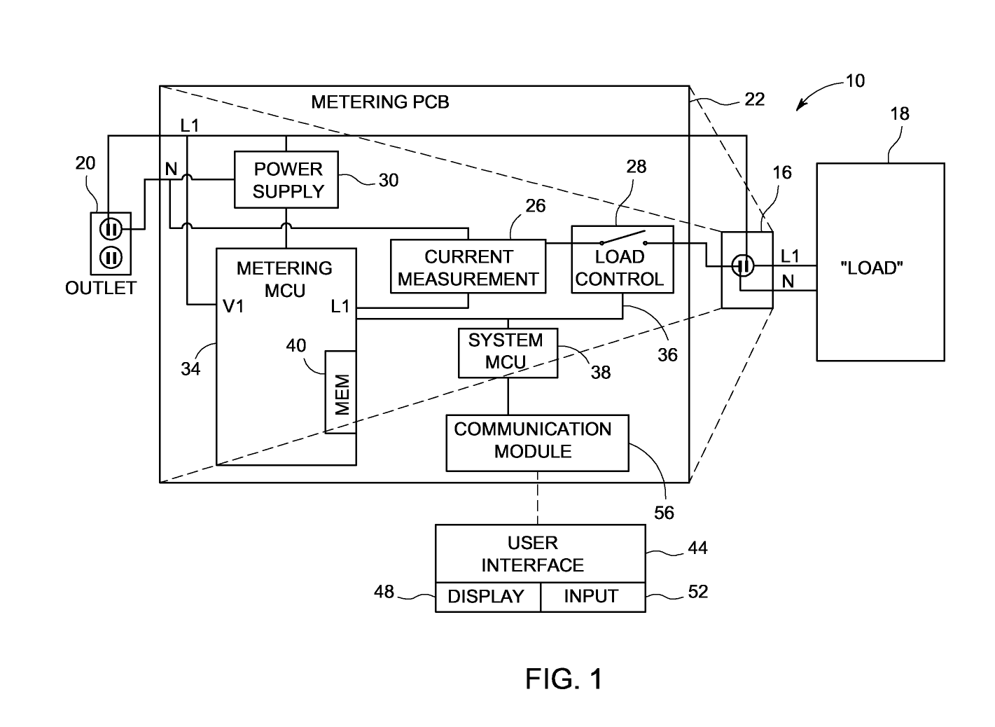

Referring to FIG. 1, an exemplary power measurement and load control system incorporating aspects of the disclosed embodiments is generally designated by reference numeral 10. The aspects of the disclosed embodiments are generally directed to a metering and power control device for an appliance. The device is generally configured to monitor the electrical power that is being consumed by the appliance, as well as the state of electrical power that is being delivered to the appliance. The device is configured to control, manage and protect the operation of the appliance in dependence upon the power consumption and power delivery states. The term “power” will generally be understood to include the values of voltage and current that can be used to calculate power based on the load conditions.

As shown in FIG. 1, the system 10 generally includes a main power supply or outlet 20 for providing electrical power to a load 18, also referred to herein as an appliance. In the example shown in FIG. 1, the outlet 20, which in a residential application, receives electric power through a residential power supply system, such as that typical provided by a utility company. In alternate embodiments, the power delivered to the outlet 20 can be provided by any suitable source, such as a commercial power supply system, or a generator, for example.

As shown in FIG. 1, the outlet 20 has or provides a first power supply line or connection L1 and a neutral line or connection N, as those are generally understood in the art. In alternate embodiments, any suitable number of power supply lines, also referred to as phases, can be provided, depending upon the application. The power supply can include for example a 120 VAC or 240 VAC supply, as is generally understood. Although the outlet 20 is shown as a two-prong outlet, in alternate embodiments, any suitable outlet configuration can be used, including, for example, three or four prong outlets. For purposes of the description herein, the electrical power to the outlet 20 is provided by a utility company via an electrical meter in a conventional residential application and is distributed to one or more loads 18. Examples of such loads 18 can include, but are not limited to, electric appliances, lights, heaters, microwave ovens, air conditioners, electric ranges, washing machines, clothes dryers, electronic equipment, computing devices, or any other electrically powered devices that can be coupled to the outlet 20.

In one embodiment, as shown in FIG. 1, a power measurement device 22 (also referred to herein as a metering device) is connected to the power supply outlet 20. As is shown in FIG. 1, the measurement device 22 generally comprises a stand-alone device that is electrically coupled, or acts as an electrical interface, between the source of electrical power or outlet 20 and the load 18. In one embodiment, the measurement device 22 is removably coupled between the outlet 20 and the load 18 and provides a flow-through electrical connection between the outlet 20 and the load 18. This allows the measurement device 22 to be used with, or plugged into different outlets 20 and different loads 18. In the embodiment shown in FIG. 1, the measurement device 22 can include a connector or outlet 16 that allows the load 18 to be removably coupled to the measurement device 22.

In the exemplary embodiment of FIG. 1, the measurement device 22 generally includes a power supply 30. In this example, the power supply 30 is connected to the lines L1 and N from the outlet 20 for receiving power therefrom. The power measurement device 22 also includes a current measurement device 26. The current measurement device 26, which in one embodiment comprises a current transformer, is associated or coupled to one of the power input line L1 or N, which in this example is shown as the N line or leg. In alternate embodiments, the current measurement device 26 can comprise any suitable device for measuring power, including voltage and current type metering and measurement devices. The current measurement device 26 which is connected in series between the outlet 20 and the load, provides a current measurement in the form of a voltage signal proportional to the current flowing in the N leg. Alternatively, the current measurement device 26 can be configured to provide an output signal representing the sensed current in the form of a current that is proportional to the sensed current. For example, a 4-20 ma signal is common in such measurements.

In one embodiment, the measurement device 22 includes a load control device 28 that is coupled between the outlet 20 and the load 18. The load control device 28, which in one embodiment comprises an electronically controlled switch, can be used to interrupt the electrical connection or supply between the outlet 20 and the load 18, as is further described herein.

In the embodiment shown in FIG. 1, the power measurement device 22 includes a controller 34, also referred to herein as a metering microcontroller unit. The controller 34 is generally configured to receive a voltage input V1 and a current input I1, and calculate the power consumption of the load 18 based on the voltage input V1 and current input I1. The voltage input V1 represents the voltage being supplied from the outlet 20 and the current input I1 represents power consumption or draw of the load 18. In this embodiment, the current draw I1 of the load 15 is measured by the current measurement device 26. As will be understood in the art, power consumption can be calculated as a product of voltage and current.

The controller 34 generally includes one or more processors that are operable to process the voltage and current inputs and calculate the consumed power, or energy, as is further described herein. In one embodiment, the controller 34 is comprised of machine-readable instructions that are executable by a processing device. The controller 34 can also include or be coupled to a memory 40 in communication with the processor, the memory 40 including program instructions for execution by the processor to carry out the processes described herein. Although the memory 40 is shown in FIG. 1 as being integral to the controller 34, in one embodiment, the memory 40 can be external to the controller 34.

The controller 34 is configured to calculate the power consumption of the particular load 18 based on supply voltage value V1 and the current input I1. Based on the voltage input and current input, the power consumption of the load 18 can determined and monitored calculated, as is described below.

In one embodiment, the measurement device 22 can also include or be coupled to a system controller 38. Although the system controller 38 is shown as a device separate from the controller 34, in one embodiment the two devices can be integrated into a single controller component or device. The system controller 38 is generally configured to form a configuration interface and load control module. The controller 38 generally includes one or more processors that are operable to process the information and data generated by the controller 34 in accordance with configuration rules, as is further described herein. In one embodiment, the controller 38 includes machine-readable instructions that are executable by a processing device. The controller 38 allows for the application specific configuration of the measurement device 22, as well as for the establishment of operational rules and parameters, and setting threshold limits corresponding to the rules, as will be further described herein.

In one embodiment, a configuration or communication module 56 is included in or communicatively coupled to the measurement device 22. In the example shown in FIG. 1, the configuration module 56 is coupled to the system controller 38. Although the controller 38 and configuration module 56 are shown as separate components, in one embodiment, they can be integrated into a single device or controller. The configuration module 56 is generally configured to enable a user to configure the measurement device 22 by establishing rules and parameters from which the measurement device 22 will make decisions regarding the control of the load(s) 18. In one embodiment, the configuration module 56 is enabled to receive information and date, such as configuration information, as well as enable the transmission of data and information from the measurement device 22 to other measurement devices 22 or loads 18, or network connected systems and devices. For example, in one embodiment, the measurement device 22 is configured to provide information regarding a state of the power being supplied from the utility to other measurement devices 22 or systems.

In one embodiment, the configuration module 56 comprises or is coupled to a user interface 44. The user interface 44 can include a display 48 and/or a user input device 52, for allowing a user to interface with the device 22. The user interface 44 can be remotely coupled to the measurement device 22 or be part of a computer system or other device interface to the measurement device 22. In alternate embodiments, the user interface 44 can comprise any suitable device or system that allows a user to interact with, receive information from, and configure the measurement device 22. Examples can include, but are not limited to, a cellular phone, a personal digital assistant, a tablet device, a personal computer, or other suitable metering device or instrument. In one embodiment, the user interface 44 can include a touch or proximity sensitive display.

The user interface 44 will allow the user to configure the measurement device 22 as will be further described herein. Once the power consumption data is calculated, the data and information relating to the power consumption and control of the load 18 can be communicated to the user via the user interface 44. This can include, for example, presenting information related to the quality of or variations in the supply voltage, information related to power consumption, such as instantaneous or average current, kilowatt hours consumed or whether power to the load 18 has been reduced or interrupted. In one embodiment, this information could be provided on or through the display 48.

Although the user interface 44 is shown to have a direct connection to the configuration module 56 of the measurement device 22, in one embodiment, the connection between the user interface 44 and the configuration module 56 can be a wireless connection. This can include any suitable wireless connection, including, but not limited to, Bluetooth, Wifi, infrared, or cellular. In one embodiment, the configuration module 56 is configured to connect with and/or communicate with a network, such as a Local. Area Network (LAN) or the Internet. For example, the measurement device 22 could be connected to the Internet for transmitting and/or receiving data relating to the power consumption to a remote device or service, such as a server at a power company. The measurement device 22 could also be coupled to, and be able to communicate with, other measurement devices 22 over a network connection. In one embodiment, the measurement device 22 could also be adapted to communicate with a home energy management device of a home energy management (HEM) system. An exemplary HEM system is described in commonly-assigned U.S. patent application Ser. No. 12/559,636, filed on Sep. 15, 2009, which is hereby incorporated by reference herein in its entirety.

In one embodiment, the configuration module 56 is configured to allow a user to program and configure the measurement device 22. The aspects of the disclosed embodiments enable one or more rules to be established in the controller 38 that can be used for decision making related to the operation of the load 18. The rules can be dependent upon or utilize any number of parameters related to the power consumption of the load 18. These parameters can include, but are not limited to, duration, time and quality of the power.

The parameters, settings and control options related to the voltage, current and power measurements and calculations can be configured in the measurement device 22. These parameters can include threshold values or limits, which if detected, can be used to generate alerts and control and/or manage downstream devices, such as the load 18. In the event a threshold value or limit is detected corresponding to a rule configured in the controller 38, the controller 38 can generate an alert or other suitable notification. In one embodiment, the alert can be presented on the user interface 44 or transmitted to other measurement devices coupled to a network of measurement devices 22. In alternate embodiments, the alert can be provided in any suitable manner. Examples can include, but are not limited to, a light or LED on the measurement device 22 that is illuminated when an alert is generated, or an audible alert. In one embodiment, the alert can be transmitted to a remote report monitoring device or system, such as for example, the utility company or the home energy management system.

In one embodiment, the controller 34 can be configured to interrupt or shut off power to the load 18 in the event a threshold value or limit is detected. As is shown in FIG. 1, the load control device 28 is coupled between the current measurement device 26 and the outlet 16 to which the load 18 is electrically coupled. In one embodiment, the load control device 28 comprises a switch. In the example shown in FIG. 1, the control line 36 for the load control device 28 is coupled to the controller 34 and the controller 38. In one embodiment, when the controller 38 determines that a threshold value or limit is detected corresponding to a rule that is active, the controller 38 can generate a control signal on the control line 36 that causes the load control device 28 to shut off the power to the load 18. In the embodiment where the load control device 28 is a switch, the control signal on control line 36 causes the switch to open.

The controller 34 is configured to calculate the power consumption based on the voltage of the power signal received at outlet 20 and provided to voltage input V1, and the current value provided to the current input I1 from the current measurement device 26. A typical power measurement device captures a voltage and a current input measurement many times a second and then multiplies the instantaneous voltage by the instantaneous current. These values are then stored in a register or memory and normalized to watt-seconds by dividing by the number of samples per second. With the load 18 activated, controller 34 measures the power consumption. The power consumption values, including the values for V1 and I1 can then be provided to the controller 38, where the measured and determined values can be compared to the pre-set or pre-determined values for the various configurations and rules of the measurement device 22, for controlling or managing the load 18, as will be further described herein.

In one embodiment, the measurement device 22 is configured to monitor the line voltage being provided from the outlet 20 for detecting abnormalities on the line, such as an under or over-voltage condition or transients. The thresholds or limits for the under or over-voltage condition can be pre-set in the measurement device 22 as a default limit, or configured by the user through the communication module 56. In the event an under or over-voltage condition is detected, the controller 38 can generate an alert as well as interrupt or shut off power to the connected load 18, depending upon how the measurement device 22 is configured and programmed. In one embodiment, when the controller 38 determines that an under or over-voltage condition exists, the controller 38 can generate a control signal on the control line 36 that causes the load control device 28 to shut off the power to the load 18. Similarly, if the controller 34 detects transients on the voltage line V1, such as for example, voltage spikes, the controller 34 can communicate this information to the controller 38, where the transient or peak voltage data can be compared to pre-set parameters for determining whether to disconnect the power line from the load 18 to prevent damage to the load 18.

In another embodiment, the measurement device 22 can be configured to detect an excess current draw from the load 18. This can include detecting the instantaneous current draw or the current draw over a pre-determined time duration. The current draw and time can be configurable parameters based upon the application. For example, decorative lights formed in string sets are typically connected in series. When one set of lights is coupled to another set of lights, the amount of current drawn by the combined set of lights increases, relative to the current drawn from a single string. Typically, the wiring for these light sets have limitations with respect to the maximum current that is supported. Exceeding the current limits can pose safety risks and concerns. The measurement device 22 can be configured or programmed with threshold values or limits for the maximum current draw through the light strings. If a threshold limit is detected, the measurement device 22 can report this information as well as enable the interruption of delivered power through load control device 28. The measurement device 22 could also be configured to interrupt the power to the load 18 if there is an unexpected increase in power draw over time. Both the power and time limits can be configurable in the measurement device 22.

In one embodiment, the measurement device 22 can be configured to monitor current and voltage limit parameters, which can be used to reduce overall power consumption or optimize energy usage of the loads 18. For example, the measurement device 22 can be programmed with a maximum power consumption value, which can be in the form of an energy unit, such as kilowatts, or a cost of the energy. If the power consumption of the load exceeds this maximum power consumption value, the power to the load 18 interrupted. In one embodiment, a maximum energy cost parameter can be programmed. If the cost of the energy consumed by the load 18 exceeds this parameter, the power to the load 18 interrupted. Cost and pricing information related to power consumption can be programmed into the measurement device 22, or obtained by the measurement device 22, from for example, the utility company. In some areas, rate information can be obtained from the utility company online, or is delivered from the utility company the measurement device 22 via the communication interface 56, in a manner that is generally understood.

In one embodiment, the measurement device 22 can be responsive to a universal command to shed load. For example, the measurement device 22 can be configured to receive demand response requests from the utility company or energy supplier to reduce or shed load during high demand or electrical use conditions. The measurement device 22 can shed load by interrupting the power supply to the load 18. In one embodiment, the measurement device 22 can be configured to ignore such demand response requests. Whether the measurement device 22 acts responsively to, or ignores such demand response requests, can be part of the initial configuration of the measurement device 22, as is described herein.

The measurement device 22 can also be configured as a time-based device that only provides an electrical power connection for a pre-determined period of time, or only during certain time periods during the day. For example, the measurement device 22 can be pre-configured with a time rule that includes a time element parameter. In one embodiment, the time rule or control parameter can allow energy consumption for a pre-set period of time, e.g. 2 hours. If the power consumption of the load reaches the set limits, load control device 28 is controlled to interrupt the power supply. The time element can also be configured to allow the consumption of power for a set period of time. For example, when the consumption of power by the load 18 is detected by the controller 38, the elapsed time can be measured. If the elapsed time meets or exceeds a set limit, the power to the load 18 can be interrupted. The controller 38 can also enable the supply of power to the load 18 during certain time periods, such as for example from 6:00 PM to 8:00 PM. In this manner, the measurement device 22 can be used to replace the typical timer based mechanism. Applications can include, for example, sprinkler systems, heated driveways and timer-based lighting systems.

In one embodiment, the price per energy unit, such as kilowatt hour, can be used as a limiting factor. For example, the measurement device 22 can be configured to limit the energy consumed by the price during a pre-determined time period. This finds application in environments such as a laundromat, where units can be loaded in the measurement device 22 with a price limiter. For example, a dryer might be operated until a pre-set price (cost of operation) limit is reached. The power to the load 18 will be interrupted once the price limit is reached. The price and time units are scalable and configurable.

In one embodiment, the measurement device 22 can be configured to measure a frequency of the voltage on the line L1, including for example, the peak and true RMS of the line voltage. This measurement and detection can be advantageous for early detection of brown out and black out conditions. Once this information is known, it can be transmitted to other devices within the network. Alerts and other notification and control management options can include for example, system save operations, clean resets and switching to back-up power, such as battery or super capacitor power supplies.

The measurement device 22 can also be configured to provide voltage spike detection and monitoring. This type of detection scheme can be used as an earlier indicator to all devices and equipment that are coupled to the power supply feeding the outlet 20. When the communication interface 56 is coupled to a network, other devices that are coupled to the network can receive the information and notifications from the measurement device 22 and be controlled accordingly.

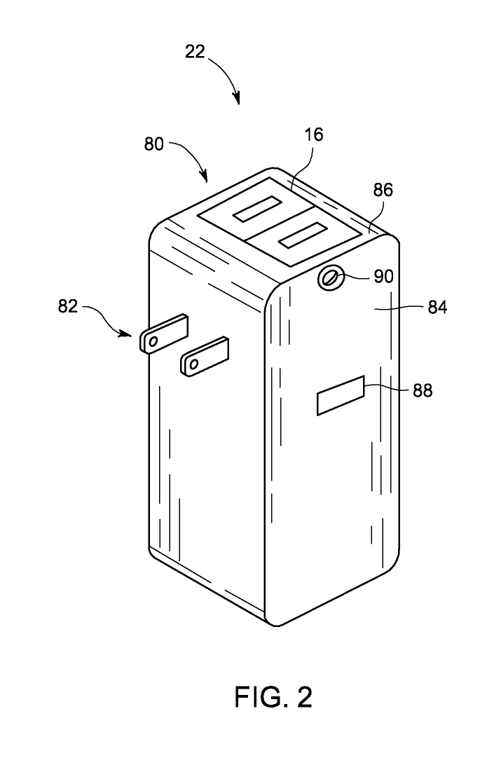

Referring to FIG. 2, one embodiment of an exemplary power measurement device 22 is illustrated. In this example, the power measurement device 22 is in the form of a wall mountable unit 80. As shown in FIG. 8, the unit 80 includes a plug 82, which in this example is shown as a standard two prong plug, adapted to be received in a conventional outlet, such as the outlet 20 illustrated in FIG. 1. In one embodiment, the plug 82 could be a standard three-prong plug unit. In alternate embodiments, any suitable plug can be used. In the example shown in FIG. 2, the wall mountable unit 80 takes the shape of a “wall wart” that is plugged into a wall outlet 20 which supports the unit 80 as well as provides power thereto.

The unit 80 includes a housing 84 in which the components of FIG. 1 such as the power supply 30, controller 34, system controller 38, configuration interface 56, etc., may be housed. In one embodiment, the unit 80 includes an electrical connection or outlet 16 on a surface thereof. In the example shown in FIG. 2, the electrical outlet 16 is shown on a top surface 86 of the housing 84. In alternate embodiments, the outlet 16 can be provided along any suitable surface of the housing 84, such as the back, bottom or side. In one embodiment, more than one electrical outlet 16 may be provided in the unit 80.

In one embodiment, the unit 80 can include a port or connection 88. The port 88 is generally configured to provide a communication connection between the measurement device 22 and the user interface 44, as described herein. In one embodiment, the port 88 comprises a USB port, or other suitable communication connection type. However, as is also noted herein, the connection between the measurement device 22 and the user interface 44 can be via a wireless connection. In one embodiment, the measurement device 22 can also include one or more lights or LEDs 90 that can provide a visual alert or notification when a threshold or limit is detected, as is described herein. The light(s) 90 can be positioned on any suitable surface of the housing 84.

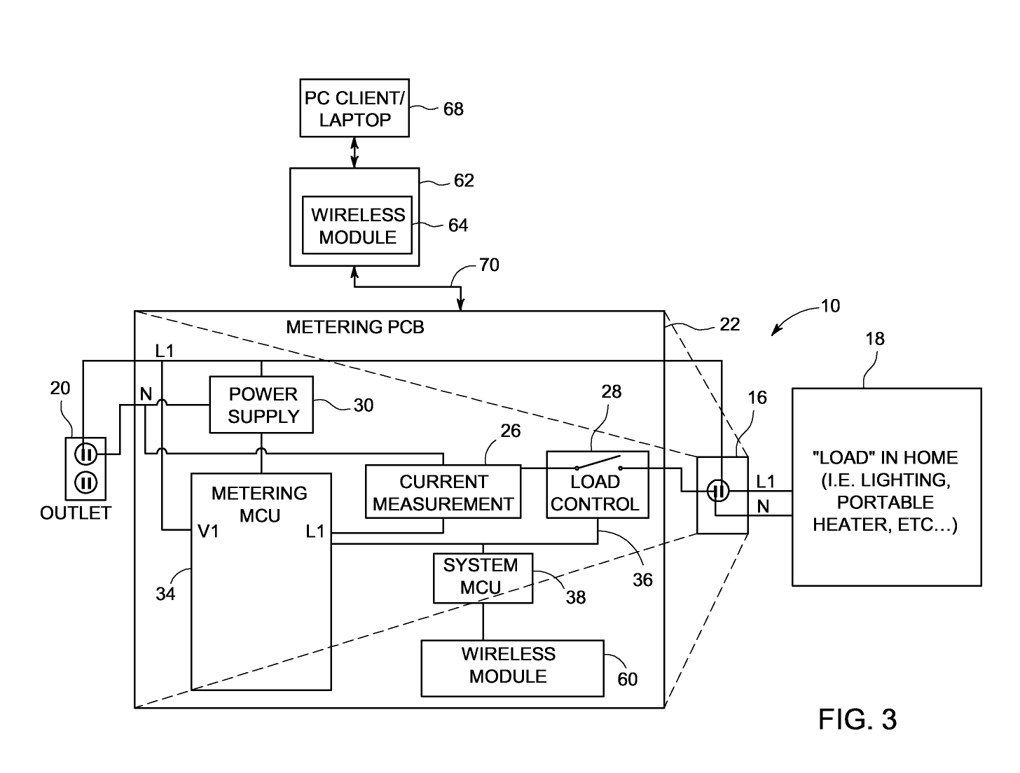

FIG. 3 illustrates an embodiment of an exemplary measurement device 22 where the configuration module 56 of FIG. 1 includes or is part of a wireless communication module 60. In this example, the wireless module 60 is configured to communicatively connect to a home energy manager or other suitable device 62 that includes a wireless module 64 over a wireless communication pathway 70. In one embodiment, the home energy manager 62 is coupled to a personal computer 68, or other computing and/or communication device, including for example a personal organizer (PDA), tablet, pad, or mobile communication device. The personal computer 68 can generally form or be part of the user interface 44 described with respect to FIG. 1. In one embodiment, the home energy manager 62 can provide instructions for configuring the measurement device 22, as is generally described herein, based on commands and instructions received from the user through the computer device 68.

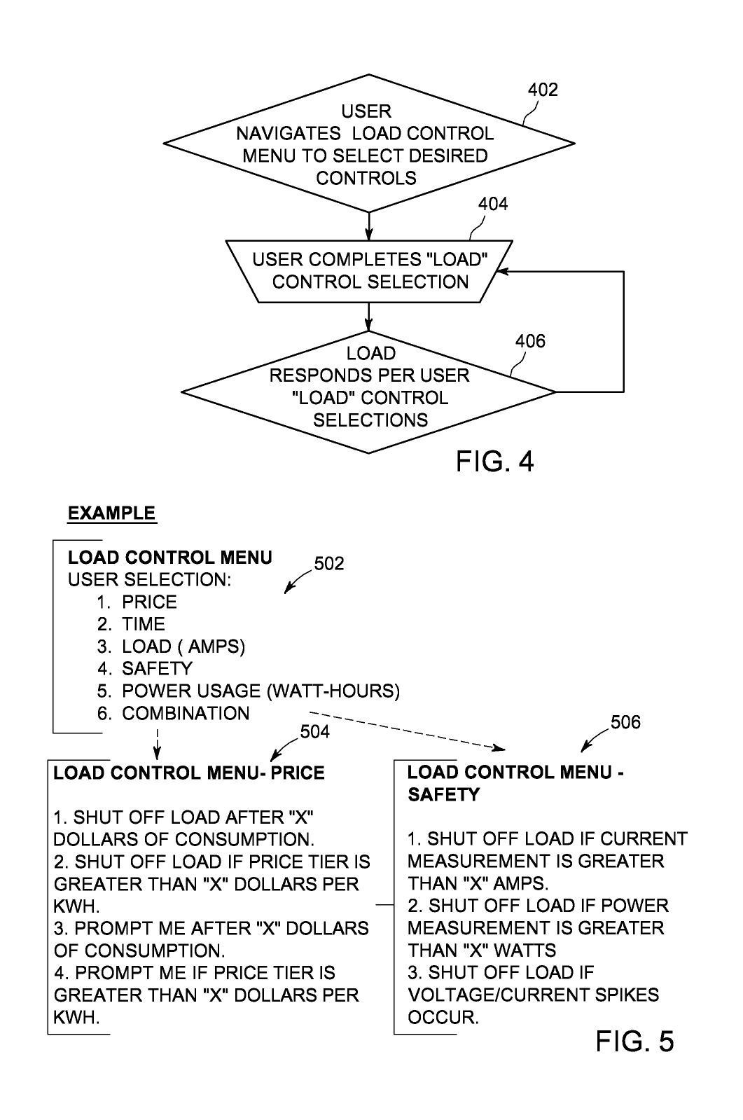

FIG. 4 illustrates an exemplary process flow diagram incorporating aspects of the disclosed embodiments. In one embodiment, during a configuration mode or state of the measurement device 22, the user can navigate 402 a Load Control menu for selecting the desired load control options. The user selects and sets 404 the desired load control options and threshold limits. During operation of the load 18, the power measurements will be monitored as is described herein and the load 18 controlled 406 accordingly.

FIG. 5 illustrates exemplary options for a load control menu incorporating aspects of the disclosed embodiments. In screen 502, a first level of Load Control menu options is shown. The options available for user selection in this example include, but are not limited to, Price, Time, Load (Amps), Safety, Power Usage (Watt-hours) and any combination thereof.

If the user selects the “Price” option shown in screen 502, a second level of “Price” options will be displayed, such as the options shown in screen 504. In this example, the selectable options or rules include: 1) Shutting off the load after the consumption of a predetermined amount of power based on the cost; 2) Shutting off the load if the cost of the supplied power exceeds a pre-determined limit; 3) Providing a prompt or notification to the user after a predetermined amount of power has been consumed, based on a cost of the consumed power; and 4) providing a prompt or notification if the basic price of the electrical power exceeds a pre-determined threshold value, such as when power prices are increased during peak periods of usage.

An example of the selection of the “Safety” option in screen 502 is illustrated in screen 506. In this menu, the user can make selections related to safety issues than may present themselves during the operation of electrically powered devices. These safety issues can include for example, under and over voltage conditions, excessive current draw, or voltage or current spikes. For example, a first option includes interrupting power to the load 18 if the measured current exceeds a pre-determined current value in terms of “amps”. A second option includes interrupting the power to the load 18 if the measured power exceeds a pre-determined value in terms of “watts.” A third option can include interrupting the power to the load 18 if voltage or current spikes are detected in the line L1. Each of the rules and threshold limits is configurable and can be set by the user in the measurement device 22.

An embodiment of the disclosure may be embodied in the form of computer-implemented processes and apparatuses for practicing those processes. Embodiments of the present disclosure may also be embodied in the form of a computer program product having computer program code containing instructions embodied in tangible media, such as floppy diskettes, CD-ROMs, hard drives, USB (universal serial bus) drives, or any other computer readable storage medium, wherein, when the computer program code is loaded into and executed by a computer, the computer becomes an apparatus for practicing the invention. Embodiments of the disclosure also may be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing aspects of the disclosure. When implemented on a general-purpose microprocessor, the computer program code segments configure the microprocessor to create specific logic circuits. A technical effect of the executable instructions is to calculate an energy supply factor and select an available energy supply source based upon a desired criterion.

The aspects of the disclosed embodiments are generally directed to a power measurement device that can effectively measure power consumption in order to manage and protect downstream loads and devices. The measurement device can be used to report error and failure conditions in the power line as well as address excess current and power-based safety concerns. The measurement device can be configured to establish power consumption thresholds and limits based on cost, time and safety.

Thus, while there have been shown, described and pointed out fundamental novel features of the invention as applied to the exemplary embodiments thereof, it will be understood that various omissions and substitutions and changes in the form and details of devices illustrated, and in their operation, may be made by those skilled in the art without departing from the spirit of the invention. Moreover, it is expressly intended that all combinations of those elements and/or method steps, which perform substantially the same function in substantially the same way to achieve the same results, are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A power measurement device for monitoring power delivered from a source of electrical power to a load, comprising:
a controller configured to receive a line voltage supply input and a current input, the current input being indicative of a current drawn by the load;
a load control device coupled between the controller and the load and configured to interrupt power supplied to the load through the measurement device; and
a configuration module coupled to the controller and configured to enable rule-based configuration of the measurement device;
the controller comprising a memory in communication with a processor, the memory comprising program instructions for execution by the processor to:
calculate a value of power consumed by the load;
compare the value of the power consumed to at least one predetermined control parameter; and
enable the load control device to interrupt power to the load based on the comparison.

2. The power measurement device of claim 1, wherein the at least one control parameter comprises a magnitude of power consumed and the controller is configured to enable the load control device to interrupt the power to the load when the calculated power value exceeds the magnitude control parameter.

3. The power measurement device of claim 2, wherein the at least one control parameter comprises a time factor, and the controller is configured to enable the load control device to interrupt the power to the load when the calculated power value exceeds the magnitude control parameter during a pre-determined time period.

4. The power measurement device of claim 1, wherein the at least one control parameter comprises a total power usage value and the controller is configured to:
calculate a total power consumed by the load;
compare the total power consumed to the total power usage value; and
enable the load control device to interrupt the power to the load when the total power consumed by the load exceeds the total power usage value.

5. The power measurement device of claim 1, wherein the at least one predetermined control parameter includes a cost of power consumed by the load and the controller is further configured to:
calculate a cost of the power consumed by the load;
compare the cost of the power consumed to the predetermined cost of power parameter; and
enable the load control device to interrupt power to the load based on the comparison.

6. The power measurement device of claim 5, wherein the at least one parameter comprises a time factor, and the controller is configured to calculate the cost value of the power consumed over a predetermined time period and interrupt the power to the load when the cost value over the predetermined time period exceeds the cost parameter.

7. The power measurement device of claim 5, wherein the at least one parameter comprises a cost per unit of energy and the controller is configured to determine a current cost per unit of energy consumed, compare the current cost per unit of energy consumed to the cost per unit of energy parameter, and interrupt the power to the load when the current cost per unit of energy exceeds the cost per unit of energy parameter.

8. The power measurement device of claim 1, wherein the at least one parameter comprises a maximum power value, and the controller is configured to interrupt power to the load when an instantaneous value of the power consumed exceeds the maximum power value.

9. The power measurement device of claim 1, wherein the at least one parameter comprises an operation time of the load, and the controller is configured to determine a time duration of operation of the load, compare the time duration of operation of the load to the operation time parameter, and interrupt the power supplied to the load when the time duration of operation of the load exceeds the operation time parameter.

10. The power measurement device of claim 1, wherein the at least one parameter comprises a power quality parameter, and the controller is configured to determine a quality of current power delivered to the load; compare the determined current power quality to the power quality parameter, and interrupt the power to the load on the basis of the comparison.

11. The power measurement device of claim 10, wherein the power quality parameter is an under/overvoltage parameter and the controller is configured to:
monitor a state of the line voltage supply input;
detect an under or over voltage condition as the determined current power quality; and
interrupt power to the load when the under or over voltage condition is detected.

12. The power measurement device of claim 10, further comprising a connection between the configuration module and a network of measurement devices, and wherein the controller is configured to transmit the current power quality information to the network of measurement devices.

13. A system for measuring power consumption of at least one device coupled to an AC power source, comprising:
a controller comprising at least one voltage input for receiving a voltage from the AC power source to which the device is connected and at least one current measurement input for receiving values of current being drawn by the device, the controller further comprising a memory in communication with a processor, the memory comprising program instructions for execution by the processor to calculate a power consumption of the device based on the at least one voltage input and the at least one current measurement input; and
a load control device coupled to the controller and configured to interrupt power to the device, the memory comprising program instructions for execution by the processor to:
compare the power consumption of the device to at least one pre-determined threshold value; and
enable the load control device to interrupt power to the load based on the at least one pre-determined threshold value.

14. The system of claim 13, further comprising a current transformer for providing the at least one current measurement input.

15. The system of claim 13, further comprising a user interface coupled to the controller, the user interface being configured to enable the at least one pre-determined threshold value to be configured in the controller.

16. The system of claim 15, wherein the user interface comprises a personal computing device.

17. The system of claim 13, further comprising a configuration module for coupling the controller to a network, the memory including program instructions for execution by the processor to determine a state of the at least one voltage supply input, compare the state of the at least one voltage input to a power quality parameter, and transmit information related to the state of the at least one voltage input over the network.

18. The system of claim 13, wherein the at least one pre-determined threshold value is a cost of power consumed by the device and the memory includes program instructions for execution by the processor to:
determine a cost of power consumed by the device;
compare the determined cost to the predetermined cost threshold value; and
enable the load control device to interrupt power to the device when the determined cost of power consumed exceeds the pre-determined cost threshold value.
